(19) United States
(12) Patent Application Publication
(10) Pub. No.: US 2018/0255406 A1
(43) Pub. Date: Sep. 6, 2018

(54) HEARING DEVICE, METHOD AND HEARING SYSTEM

(71) Applicant: GN HEARING A/S, BALLERUP (DK)

(72) Inventors: Charlotte SØRENSEN, BALLERUP (DK); Jesper Bunsow BOLDT, Malov (DK); Angeliki XENAKI, BALLERUP (DK); Mads Graesboll CHRISTENSEN, Dronningglund (DK)

(73) Assignee: GN HEARING A/S, BALLERUP (DK)

(21) Appl. No.: 15/881,327

(22) Filed: Jan. 26, 2018

(30) Foreign Application Priority Data
Mar. 2, 2017 (EP) 17158989.8

(51) Int. Cl. H04R 25/00; G10L 13/04; G10L 25/90

(52) U.S. Cl. CPC H04R 25/505; H04R 25/405; H04R 2225/43; G10L 13/043; G10L 25/90; H04R 25/407

(57) ABSTRACT

The present disclosure provides a hearing device comprising a set of microphones comprising a first microphone for provision of a first microphone input signal, and a processor for processing input signals and providing an electrical output signal based on input signals. The hearing device a receiver for converting the electrical output signal to an audio output signal, and a controller operatively connected to the set of microphones, the controller comprising a speech intelligibility estimator for estimating a speech intelligibility indicator indicative of speech intelligibility based on one or more microphone input signals. The controller is configured to control the processor based on the speech intelligibility indicator. The speech intelligibility estimator comprises a pitch estimator for estimating a pitch parameter of a first audio source. The speech intelligibility indicator is based on the pitch parameter and a direction of the first audio source.

### RELATED APPLICATION DATA

This application claims priority to, and the benefit of, European Patent Application No. EP 17158989.8, filed on Mar. 2, 2017, pending. The entire disclosure of the above application is expressly incorporated by reference herein.

### FIELD

The present disclosure relates to a hearing device, a method of operating a hearing device, and a hearing system.

### BACKGROUND

One of the main issues encountered by hearing aid (HA) users is severely degraded speech intelligibility in noisy multi-talker environments such as the “cocktail party problem”. Generally, the speech intelligibility for users of assistive listening devices depends highly on the specific listening environment. As such, a speech enhancement processing scheme may be beneficial in some listening environments and detrimental in other listening environments. Speech enhancement processing schemes do not necessarily improve speech intelligibility in any environment.

### SUMMARY

Accordingly, there is a need for hearing devices, methods and hearing systems that overcome drawbacks of the background.

A hearing device is disclosed, comprising a set of microphones comprising a first microphone for provision of a first microphone input signal, and a processor for processing input signals and providing an electrical output signal based on input signals. The hearing device a receiver for converting the electrical output signal to an audio output signal, and a controller operatively connected to the set of microphones, the controller comprising a speech intelligibility estimator for estimating a speech intelligibility indicator indicative of speech intelligibility based on one or more microphone input signals. The controller is configured to control the processor based on the speech intelligibility indicator. The speech intelligibility estimator comprises a pitch estimator for estimating a pitch parameter of a first audio source. The speech intelligibility indicator is based on the pitch parameter and a direction of the first audio source.

Further, this disclosure relates to a method of operating a hearing device. The method may be performed in a hearing device or in a hearing system. The method comprises converting audio to one or more microphone input signals including a first microphone input signal. The method comprises obtaining a speech intelligibility indicator indicative of speech intelligibility related to the first microphone input signal. Obtaining the speech intelligibility indicator may comprise obtaining a pitch parameter of a first audio source. The speech intelligibility indicator is based on the pitch parameter and a direction of the first audio source. The method comprises controlling the hearing device based on the speech intelligibility indicator.

This disclosure relates to a hearing system comprising an accessory device comprising a processor, an interface and a memory, and a hearing device. The hearing system comprises a set of microphones arranged in the hearing device, the set of microphones comprising a first microphone for provision of a first microphone input signal, and a processor for processing input signals and providing an electrical output signal based on input signals. The hearing system comprises a receiver arranged in the hearing device for converting the electrical output signal to an audio output signal, and a controller operatively connected to the set of microphones. The controller is configured to control the processor based on a speech intelligibility indicator. The hearing system is configured to estimate a speech intelligibility indicator indicative of speech intelligibility based on one or more microphone input signals. The hearing system is configured to estimate a pitch param of a first audio source. The speech intelligibility indicator is based on the pitch parameter and a direction of the first audio source.

It is an advantage of the present disclosure that it allows to assess the speech intelligibility without having a reference speech signal available. The speech intelligibility is advantageously used in the present disclosure to detect the state of the listening environment and to adapt the speech enhancement schemes accordingly. In particular, the present disclosure exploits fundamental aspects of human speech, such as pitch, to improve accuracy of the estimation of the speech intelligibility.

A hearing device includes: a set of microphones comprising a first microphone for provision of a first microphone input signal; a processor configured to provide an electrical output signal based on the first microphone input signal; a receiver configured to provide an audio output signal based on the electrical output signal; and a controller operatively connected to the set of microphones, the controller comprising a speech intelligibility estimator for estimating a speech intelligibility indicator indicative of speech intelligibility based on one or more microphone input signals that include the first microphone input signal, wherein the controller is configured to control the processor based on the speech intelligibility indicator; wherein the speech intelligibility estimator comprises a pitch estimator for estimating a pitch parameter of a first audio source, and wherein the speech intelligibility indicator is based on the pitch parameter and a direction of the first audio source.

Optionally, the speech intelligibility estimator comprises a speech synthesizer configured to generate a reconstructed speech signal based on the pitch parameter, and wherein the speech intelligibility indicator is based on the reconstructed speech signal.

Optionally, the speech intelligibility estimator comprises a short-time objective intelligibility estimator, wherein the short-time objective intelligibility estimator is configured to compare the reconstructed speech signal and a base speech signal.

Optionally, the speech intelligibility estimator comprises a harmonic model estimator operatively connected to the pitch estimator for provision of a harmonic model parameter, and wherein the pitch parameter is based on the harmonic model parameter.

Optionally, the set of microphones comprises a second microphone for provision of a second microphone input signal; and wherein the speech intelligibility estimator comprises a direction estimator for estimating the direction of the first audio source based on the first microphone input signal and the second microphone input signal.

Optionally, the hearing device is configured to, if the speech intelligibility indicator meets a first criterion, apply a first processing scheme.

Optionally, the hearing device is configured to, if the speech intelligibility indicator does not meet a first criterion, continue applying a same processing scheme as previously applied.

Optionally, the first criterion is based on a first intelligibility threshold.

Optionally, the speech intelligibility indicator meets the first criterion when the speech intelligibility indicator is below the first intelligibility threshold.

Optionally, the hearing device is configured to, if the speech intelligibility indicator meets a second criterion, apply a second processing scheme that is different from the first processing scheme.

Optionally, the first processing scheme, the second processing scheme, or each of the first and second processing schemes, comprises a beamforming scheme, a noise reduction scheme, a gain control scheme, a compression scheme, or a combination of the foregoing.

A method of operating a hearing device includes: providing one or more microphone input signals including a first microphone input signal; obtaining a speech intelligibility indicator indicative of speech intelligibility related to the first microphone input signal, wherein the act of obtaining the speech intelligibility indicator comprises obtaining a pitch parameter of a first audio source, and wherein the speech intelligibility indicator is based on the pitch parameter and a direction of the first audio source; and controlling the hearing device based on the speech intelligibility indicator.

Optionally, the act of obtaining the pitch parameter of the first audio source comprises estimating the pitch parameter, and wherein the act of obtaining the speech intelligibility indicator comprises estimating a speech intelligibility indicator based on the one or more microphone input signals.

Optionally, the act of obtaining the speech intelligibility indicator comprises generating a reconstructed speech signal based on the pitch parameter, and wherein the speech intelligibility indicator is based on the reconstructed speech signal.

A hearing system includes an accessory device and a hearing device, wherein the hearing system comprises: a set of microphones arranged in the hearing device, the set of microphones comprising a first microphone for provision of a first microphone input signal; a processor configured to provide an electrical output signal based on the first microphone input signal; a receiver arranged in the hearing device for providing an audio output signal based on the electrical output signal; and a controller operatively connected to the set of microphones, wherein the controller is configured to control the processor based on a speech intelligibility indicator; wherein the hearing system is configured to estimate a speech intelligibility indicator indicative of speech intelligibility based on one or more microphone input signals that include the first microphone input signal; and wherein the hearing system is configured to estimate a pitch parameter of a first audio source, and wherein the speech intelligibility indicator is based on the pitch parameter and a direction of the first audio source.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary hearing device according to the disclosure,

FIG. 2 is a flow diagram of an exemplary method according to the disclosure,

FIG. 3 schematically illustrates an exemplary hearing system according to the disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

It has been realized by the inventors that automatic intelligibility assessment of the listening environment may be beneficial for the user of a hearing device such that a speech enhancement scheme can be controlled based on the assessed speech intelligibility of the listening environment and is thereby only applied when necessary. Thus, the inventors have found benefits in using a speech intelligibility indicator in the processing of a hearing device. To assess speech intelligibility, there exists various intrusive methods to predict the speech intelligibility with acceptable reliability such as the short-time objective intelligibility (STOI) metric and the normalized covariance metric (NCM).

However, the STOI method, and the NCM method are intrusive, i.e., they all require access to the “clean” speech signal as a reference speech signal. The “clean” speech signal is a reference speech signal, which exhibits similar properties as the signal emitted by an audio source, such as sufficient information about the speech intelligibility. The “clean” speech signal can be provided by the audio source, for example, when the audio source is equipped with a spouse microphone device. However, in most real life situations, such as the cocktail party, access to the “clean” speech signal as reference speech signal is rarely available.

EP 3 057 335 A1 describes a binaural system comprising left and right hearing devices adapted for being located at or in left and right ears of a user, and a binaural speech intelligibility prediction unit for providing a binaural SI-measure of the predicted speech intelligibility of the user when exposed to said output stimuli, based on the processed signals yl(t), yr(t) from the signal processing units of the respective left and right hearing devices.

However, the system of EP 3 057 335 A1 is also intrusive in that it requires access to the processed speech signal from the left hearing device as the reference speech signal. The binaural system of EP 3 057 335 A1 relies on the processed signal from one of the hearing devices to be used as reference speech signal in predicting speech intelligibility. Such technique is not applicable to a monaural hearing system because it is not possible to obtain a processed signal from another hearing device in a monaural hearing system, and, as such, there is no reference speech signal readily available in the monaural hearing system. Further, the system of EP 3 057 335 A1 provides a sub-optimal speech intelligibility estimation because the processed signal from e.g. the left hearing device is likely to suffer from the same speech intelligibility deficiencies as the signal from the right hearing device, and thereby cannot be seen as a reliable reference speech signal.

The present disclosure provides a hearing device that non-intrusively estimates the speech intelligibility of the listening environment by estimating a speech intelligibility indicator based on the microphone input signals and a pitch parameter of an audio source in the listening environment. The present disclosure proposes to use the estimated speech intelligibility indicator to control the processing of microphone input signals.

It is an advantage of the present disclosure that no access to a reference speech signal is needed in the present disclosure to estimate the speech intelligibility indicator. The present disclosure proposes a hearing device, a method and a hearing system that is capable of reconstructing the reference speech signal (i.e. a reference speech signal representing the intelligibility of the speech signal) based on the pitch parameter and the microphone input signals. The present disclosure overcomes the lack of availability or lack of access to a reference speech signal by exploiting the microphone input signals, the pitch parameter and the direction of arrival.

A hearing device is disclosed herein. The hearing device may be a hearing aid, wherein the processor is configured to compensate for a hearing loss of a user. The hearing device may be a hearing aid, e.g. of a behind-the-ear (BTE) type, in-the-ear (ITE) type, in-the-canal (ITC) type, receiver-in-canal (RIC) type or receiver-in-the-ear (RITE) type.

The hearing device comprises a set of microphones. The set of microphones may comprise one or more microphones. The set of microphones comprises a first microphone for provision of a first microphone input signal and/or a second microphone for provision of a second microphone input signal. The set of microphones may comprise N microphones for provision of N microphone signals, wherein N is an integer in the range from 1 to 10. In one or more exemplary hearing devices, the number N of microphones is two, three, four, five or more. The set of microphones may comprise a third microphone for provision of a third microphone input signal.

The hearing device comprises a processor for processing input signals, such as microphone input signal(s). The processor provides an electrical output signal based on the input signals to the processor. Input terminal(s) of the processor are optionally connected to respective output terminals of the microphones. One or more microphone input terminals of the processor may be connected to respective one or more microphone output terminals of the microphones. The processor may be configured to compensate for a hearing loss of a user and to provide an electrical output signal based on input signals.

The hearing device comprises a receiver for converting the electrical output signal to an audio output signal. The receiver may be configured to convert the electrical output signal to an audio output signal to be directed towards an eardrum of the hearing device user.

The hearing device optionally comprises an antenna for converting one or more wireless input signals, e.g. a first wireless input signal and/or a second wireless input signal, to an antenna output signal. The wireless input signal(s) origin from external source(s), such as spouse microphone device(s), wireless TV audio transmitter, and/or a distributed microphone array associated with a wireless transmitter.

The hearing device optionally comprises a radio transceiver coupled to the antenna for converting the antenna output signal to a transceiver input signal. Wireless signals from different external sources may be multiplexed in the radio transceiver to a transceiver input signal or provided as separate transceiver input signals on separate transceiver output terminals of the radio transceiver. The hearing device may comprise a plurality of antennas and/or an antenna may be configured to be operate in one or a plurality of antenna modes. The transceiver input signal comprises a first transceiver input signal representative of the first wireless signal from a first external audio source.

The hearing device comprises a controller. The controller may be operatively connected to the first microphone and to the processor. The controller may be operatively connected to the second microphone if present. The controller may comprise a speech intelligibility estimator for estimating a speech intelligibility indicator indicative of speech intelligibility based on one or more microphone input signals. The controller may be configured to estimate the speech intelligibility indicator indicative of speech intelligibility based on one or more microphone input signals. The controller is configured to control the processor based on the speech intelligibility indicator.

The speech intelligibility estimator may comprise a pitch estimator for estimating a pitch parameter of a first audio source. The speech intelligibility indicator is based on the pitch parameter and a direction of the first audio source. The direction of the first audio source is for example the direction of arrival of the microphone input signal received at a microphone from the first audio source. For example, the controller or the speech intelligibility estimator may be configured to estimate the speech intelligibility indicator based on the pitch parameter and a direction of the first audio source. Stated differently, the speech intelligibility indicator is predicted by the controller or the speech intelligibility estimator based on the pitch parameter and a direction of the first audio source. The direction may be known (e.g. assuming frontal direction facing the nose of the user) or estimated jointly with the pitch parameter according to this disclosure.

In one or more exemplary hearing devices, the processor comprises the controller. In one or more exemplary hearing devices, the controller is collocated with the processor.

In one or more exemplary hearing devices, the speech intelligibility estimator comprises a speech synthesizer for generating a reconstructed speech signal based on the pitch parameter. The speech intelligibility indicator may be based on the reconstructed speech signal. The reconstructed speech signal may be considered as a reference speech signal representing the intelligibility of the microphone input signal. In other words, the speech synthesizer is configured to reconstruct a speech signal based on the pitch parameter, and to synthesize the reconstructed speech signal. For example, the controller or the speech intelligibility estimator may be configured to generate a reconstructed speech signal based on the pitch parameter, and to estimate the speech intelligibility indicator based on the reconstructed speech signal, the pitch parameter and a direction of the first audio source. It may be seen that the speech intelligibility indicator is predicted by the controller or the speech intelligibility estimator based on the synthesized and reconstructed speech signal. The reconstructed speech signal may be seen as a reconstructed reference speech signal. Combining the direction of the first audio source (i.e. a spatial cue) and the pitch parameter (i.e. temporal cue) improves the accuracy of the reconstruction of the reference speech signal as the disclosed technique resolves ambiguities, e.g. due to reverberation or competing speakers.

In one or more exemplary hearing devices, the speech intelligibility estimator comprises a short-time objective intelligibility (STOI) estimator. The short-time objective intelligibility estimator may be configured to compare the reconstructed speech signal and a base speech signal based on one or more microphone input signals. The short-time objective intelligibility estimator may be configured to provide the speech intelligibility indicator based on the comparison. The base speech signal refers to the noisy speech signal as obtained from the one or more microphones and provided to the receiver. The base speech signal may be captured by a single microphone (which is omnidirectional) or by a plurality of microphones (e.g. using beamforming). For example, the speech intelligibility indicator may be predicted by the controller or the speech intelligibility estimator by comparing the reconstructed speech signal and the base speech using the STOI estimator, such as by comparing the correlation of the reconstructed speech signal and the base speech using the STOI estimator.

In one or more exemplary hearing devices, the speech intelligibility estimator comprises a harmonic model estimator operatively connected to the pitch estimator for provision of harmonic model parameters of the microphone input signals. The pitch parameter may be based on the harmonic model parameters. For example, the harmonic model parameters comprise a fundamental frequency, a sampling frequency, a delay of a signal from the first audio source to the one or more microphones giving the direction of arrival, an attenuation of the signal from the first audio source, an amplitude (e.g. a complex amplitude), a number of harmonics, a real amplitude of a harmonic, and/or a phase of a harmonic.

In one or more exemplary hearing devices, the harmonic model estimator is configured to provide harmonic model parameters of the microphone input signals based on a harmonic model structure of a multi-channel signal, wherein a channel corresponds to the microphone. The harmonic model structure may be seen as a spatio-temporal harmonic model structure. The first audio source may be considered as the desired audio source, and assumed to be periodic. For example, the reconstructed speech is generated by estimating signal properties based on considering the microphone input signals received from the first audio source as a number of narrowband signals with harmonically related carrier frequencies using a spatio-temporal harmonic model.

In one or more exemplary hearing devices, the pitch estimator is configured to receive the harmonic model parameters and to estimate the pitch parameter based on the harmonic model parameters and a log-likelihood function.

In one or more exemplary hearing devices, the pitch estimator comprises a maximum likelihood estimator for estimating the pitch parameter based on the log-likelihood function and the harmonic model parameters.

In an illustrative example where the disclosed technique is applied, a multi-channel spatio-temporal harmonic model is applied in order to generate the reconstructed speech signal as input to the STOI estimator. In the illustrating example, it is assumed that K microphones are used to obtain the desired microphone input signals added to a mixture of interfering sources and background noise for a frame length of N. For the k'th microphone, the microphone input signals obtained by the microphones can be represented by a data vector xₖ=[xₖ(0)xₖ(1) . . . xₖ(N−1)]^{T} for k=0, . . . , K−1. The desired audio source is assumed to be periodic, which is an appropriate assumption for short segments of voiced speech. As such, the data vector xₖ can be modelled as:

xₖ=βₖZD(k)α+eₖ (1)
where Z=[z(ω₀) . . . z(Lω₀)], z(lω₀)=[1 . . . e^{jlω}^{₀}^{(N-1)}] for n=0, . . . , N−1, D(k)=diag([e^{-jω}^{₀}^{f}^{ₛ}^{τ}^{ₖ} . . . e^{-jLω}^{₀}^{f}^{ₛ}^{τ}^{ₖ}]) for l=1, . . . , L with all other entries equal to zero;
eₖ denotes the sum of the recorded noise and interference;
ω₀ is the fundamental frequency, fs is the sampling frequency;
τₖ is the delay of the input signals between microphone ( ) and the k'th microphone giving the direction of arrival (DOA);
βₖ is the attenuation of the microphone input signal at the k'th microphone,
   α=[α₁ . . . α_{L}]^{T} denotes complex amplitudes given by the l'th complex amplitude α=Aₗe^{jφl};
L is the number of harmonics;
Aₗ [symbol] O and φₗ φₗ are the real amplitude and phase of the l'th harmonic, respectively.

In an illustrative example where the disclosed technique is applied, it is assumed that the noise is uncorrelated white Gaussian with variance σₖ² in each microphone or each microphone channel, the log-likelihood function of the complex data vector xₖ can be written as:

$$ln p ( {x}_{k} ; ψ ) = - NK ln π - N {\sum }_{k = 0}^{K - 1} ln {σ}_{k}^{2} - {\sum }_{k = 0}^{K - 1} \frac{{‖ {e}_{k } ‖}^{2}}{{σ}_{k}^{2}} \qquad ( 2 )$$

where ψ denotes a vector containing the signal parameters for xₖ. In this example, the white Gaussian noise distribution maximizes the entropy of the noise and is therefore a good choice for the noise probability density function. The pitch can be estimated by maximizing the log-likelihood function by differentiating with respect to the amplitudes \hat{α}, the attenuation factor βₖ, and the noise variance σₖ² respectively. These parameters are dependent on each other and are therefore estimated by initially setting βₖ's and σₖ²'s to 1 and iterating over the expressions in Equation (3), (4) and (5). The estimated complex amplitudes are given by:

$$\hat{α} = {[ {\sum }_{k = 0}^{K - 1} \frac{{β}_{k}^{2}}{{σ}_{k}^{2}} {D}^{H} ( k ) {Z}^{H} ZD ( k ) ]}^{- 1} {\sum }_{k = 0}^{K - 1} \frac{{β}_{k}^{2}}{{σ}_{k}^{2}} {D}^{H} ( k ) {Z}^{H} {x}_{k} \qquad ( 3 )$$

The estimated attenuation of the desired audio source at the k'th microphone can be obtained as:

$${\hat{β}}_{k} = \frac{Re \{ {α}^{H} {D}^{H} ( k ) {Z}^{H} {x}_{k} \}}{{α}^{H} {D}^{H} ( k ) {Z}^{H} ZD ( k ) α} \qquad ( 4 )$$

Moreover, the noise variance can be found as:

\hat{σ}ₖ²=N⁻¹∥xₖ−\hat{β}ₖZD(k)\hat{α}∥² (5)

where [symbol] =zₖ−βₖZD(k)α.

The pitch parameter can then be estimated using a maximum likelihood estimator written as:

$${\hat{ω}}_{0} = arg {min}_{{ω}_{0} ∈ {Ω}_{0}} {\sum }_{k = 0}^{K - 1} ln {‖ {x}_{k} - {\hat{β}}_{k} ZD ( k ) \hat{α} ‖}^{2} \qquad ( 6 )$$

where Ω₀ is a set of possible pitch parameter candidates. In this example, the direction of the first audio source is assumed known such that the estimation of the pitch parameter is performed over one dimensional search. This additionally limits the computational complexity and provides a technique that is robust against stronger interfering harmonic sources from other directions. The reconstructed speech signal for the k'th microphone can be obtained given the estimated pitch ω₀ and the delay τₖ:

ŝₖ=Π_{ZD(k)}xₖ (7)

with the projection matrix Π_{A}=A(A^{H}A)⁻¹A^{H}. The reconstructed speech signal to be used as input to the short-time objective intelligibility estimator is then obtained by summing the reconstructed speech signal over all microphone channels:

$${\hat{s}}_{k} = \frac{1}{K} {\sum }_{k = 0}^{K - 1} {\hat{s}}_{k} \qquad ( 8 )$$

Alternatively, or additionally, the variance estimates in Equation (5) can be used to form a weighted estimate of the reconstructed speech signal.

In one or more exemplary hearing devices, the set of microphones comprises a second microphone for provision of a second microphone input signal. The speech intelligibility estimator may comprise a direction estimator for estimating the direction of the first audio source based on the first microphone input signal and the second microphone input signal. The speech intelligibility indicator may be based on the direction of the first audio source. For example, the pitch parameter and the direction of the first audio source (e.g. direction of arrival of the microphone input signal) are estimated jointly at the speech intelligibility estimator or at the controller by utilizing the spatio-temporal harmonic model for the desired periodic microphone input signal received by the one or more microphones.

In one or more exemplary hearing devices, the hearing device is configured to, if the speech intelligibility indicator meets a first criterion, select and apply a first processing scheme to the microphone input signals. For example, when the speech intelligibility indicator meets a first criterion (e.g. the speech intelligibility indicator indicates that the speech intelligibility is not sufficient), a first processing scheme needs to be applied to the microphone input signals so as to improve the speech intelligibility. The first processing scheme may comprise one or more speech enhancement processing schemes. The first processing scheme may comprise one or more speech enhancement processing configured to compensate hearing loss of a user. For example, the controller may provide the speech intelligibility indicator to the processor, which may be configured to, if the speech intelligibility indicator meets a first criterion, select and apply a first processing scheme to the microphone input signals. In one or more exemplary hearing devices, the controller may be configured to, if the speech intelligibility indicator meets a first criterion, select and apply a first processing scheme to the microphone input signals.

In one or more exemplary hearing devices, the hearing device is configured to, if the speech intelligibility indicator does not meet a first criterion, continue applying to the microphone input signals the same processing scheme as previously applied. For example, when the speech intelligibility indicator does not meet a first criterion (i.e. that the speech intelligibility indicator indicates that the speech intelligibility is sufficient), the same processing scheme as previously applied does not need to be changed, and the hearing device or the processor can continue applying the same processing scheme to the microphone input signals.

The first criterion may be based on a first intelligibility threshold. In one or more exemplary hearing devices, the speech intelligibility indicator meets the first criterion when the speech intelligibility indicator is below the first intelligibility threshold. For example, the first intelligibility threshold may be in a range of 75-95%, such as 80%, 85%. For example, when the speech intelligibility indicator is below 85%, the hearing device selects and applies a first processing scheme, such as a beamforming scheme. When the speech intelligibility indicator is equal or higher than 85%, the hearing device proceeds in applying the same scheme as the previously applied processing scheme.

In one or more exemplary hearing devices, the hearing device is configured to, if the speech intelligibility indicator meets a second criterion, select and apply a second processing scheme to the first microphone input signal. The second criterion may be based on a second intelligibility threshold and third intelligibility threshold. For example, the second intelligibility threshold may be in a range of 60-75%, such as 65%, 70%. For example, the third intelligibility threshold may be in a range of 77-84%, such as 80%, 84%. For example, the speech intelligibility indicator meets the second criterion when the speech intelligibility indicator falls between the second and the third intelligibility threshold. For example, the speech intelligibility indicator meets the second criterion when the speech intelligibility indicator is equal or larger than 70% but not larger than 80%. Another example is when the speech intelligibility indicator meets a third criterion, wherein the third criterion is based on a zero threshold. For example, when the speech intelligibility indicator reaches 0%, a narrower beamforming (with a higher directivity index) is selected and applied.

It may be envisaged that various criteria (e.g. a first criterion, a second criterion, a third criterion, a fourth criterion . . . ) may be used by the hearing device to identify which processing scheme is to be selected and applied to the microphone input signals.

The first and/or second processing scheme may comprise one or more of a beamforming scheme, a noise reduction scheme, a gain control scheme, and a compression scheme. For example, the first processing scheme selected by the hearing device based on the speech intelligibility indicator may comprise a combination of a beamforming scheme and a noise reduction scheme.

In one or more exemplary hearing devices, the first and/or second processing scheme may comprise a first beamforming scheme including a first set of beamforming coefficients and/or a second beamforming scheme including a second set of beamforming coefficients.

In one or more exemplary hearing devices, the first and/or second processing scheme may comprise a noise reduction scheme providing one or more noise reduction functions resulting in an improved signal-to-noise ratio.

In one or more exemplary hearing devices, the first and/or second processing scheme may comprise a compression scheme and/or a gain control scheme, wherein a gain applied to the microphone input signal is controlled based on a hearing loss compensation. This disclosure relates to a method of operating a hearing device. The method may be performed in a hearing device or in a hearing system. The method comprises converting audio to one or more microphone input signals including a first microphone input signal. The method comprises obtaining a speech intelligibility indicator indicative of speech intelligibility related to the first microphone input signal. Obtaining the speech intelligibility indicator comprises obtaining a pitch parameter of a first audio source. The speech intelligibility indicator is based on the pitch parameter and a direction of the first audio source. The method comprises controlling the hearing device based on the speech intelligibility indicator.

In one or more exemplary methods, obtaining the pitch parameter of a first audio source comprises estimating the pitch parameter. Obtaining the speech intelligibility indicator may comprise estimating a speech intelligibility indicator based on the one or more microphone input signals.

In one or more exemplary methods, obtaining the speech intelligibility indicator comprises generating a reconstructed speech signal based on the pitch parameter, and determining the speech intelligibility indicator based on the reconstructed speech signal. Obtaining the speech intelligibility indicator may comprise comparing the reconstructed speech signal and a base speech signal, e.g. using a short-time objective intelligibility estimator. Obtaining the speech intelligibility indicator may comprise obtaining harmonic model parameters of the microphone input signals and deriving the pitch parameter based on the harmonic model parameters. Obtaining the speech intelligibility indicator may comprise estimating the direction of the first audio source based on the microphone input signals.

In one or more exemplary methods, controlling the hearing device based on the speech intelligibility indicator comprises selecting and applying a first processing scheme to the microphone input signals if the intelligibility indicator meets a first criterion. The first criterion may be based on a first intelligibility threshold. The first processing scheme may comprise one or more of a beamforming scheme, a noise reduction scheme, a gain control scheme, and a compression scheme.

In one or more exemplary methods, obtaining the pitch parameter of a first audio source may comprise receiving the pitch parameter from an external device, such as an accessory device. It may be envisaged that the estimation of the speech intelligibility indicator is performed at the external device, (e.g. online), wherein the hearing device is configured to provide the microphone input signals to an external device in order to obtain the speech intelligibility back.

It may be envisaged that the estimation of the speech intelligibility indicator and the processing of microphone input signals according to the speech intelligibility indicator is performed at the external device, (e.g. online), wherein the hearing device is configured to provide the microphone input signals to an external device in order to obtain the processed (e.g. noise reduced) microphone input signals or beamforming parameters.

This disclosure relates to a hearing system comprising an accessory device comprising a processor, an interface and a memory, and a hearing device. The hearing system comprises a set of microphones arranged in the hearing device, the set of microphones comprising a first microphone for provision of a first microphone input signal, and a processor for processing input signals and providing an electrical output signal based on input signals. The hearing system comprises a receiver arranged in the hearing device for converting the electrical output signal to an audio output signal, and a controller operatively connected to the set of microphones. The controller is configured to control the processor based on a speech intelligibility indicator. The hearing system is configured to estimate a speech intelligibility indicator indicative of speech intelligibility based on one or more microphone input signals. The hearing system is configured to estimate a pitch parameter of a first audio source. The speech intelligibility indicator is based on the pitch parameter and a direction of the first audio source.

The accessory device may be seen as accessory to the hearing device. The accessory device may be paired or otherwise wirelessly coupled to the hearing device. The hearing system may be in possession of and controlled by the hearing device user. The accessory device may be a smartphone, a smartwatch, or a tablet computer.

In one or more exemplary hearing systems, the accessory device comprises the controller which is remotely accessed by the processor of the hearing device and the speech intelligibility estimation is performed remotely from the hearing device, e.g. at accessory device.

The hearing devices, systems and methods discloses herein allow a prediction of the speech intelligibility indicator and adaptation of the processing applied to the input signals according to the predicted speech intelligibility indicator.

Throughout, the same reference numerals are used for identical or corresponding parts.

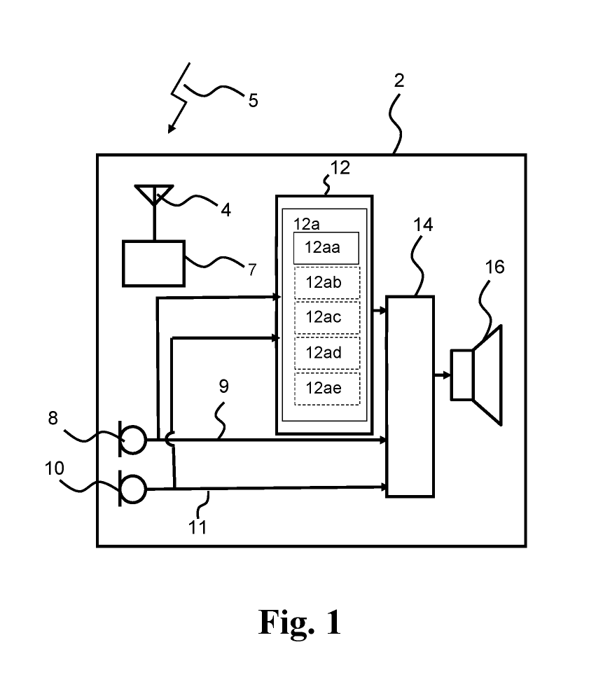

FIG. 1 is a block diagram of an exemplary hearing device 2 according to the disclosure.

The hearing device 2 comprises a set of microphones. The set of microphones may comprise one or more microphones. The set of microphones comprises a first microphone 8 for provision of a first microphone input signal 9 and/or a second microphone 10 for provision of a second microphone input signal 11.

The hearing device 2 optionally comprises an antenna 4 for converting a first wireless input signal 5 of a first external source (not shown in FIG. 1) to an antenna output signal. The hearing device 2 optionally comprises a radio transceiver 7 coupled to the antenna 4 for converting the antenna output signal to one or more transceiver input signals and to the set of microphones comprising a first microphone 8 and optionally a second microphone 10 for provision of respective first microphone input signal 9 and second microphone input signal 11.

The hearing device 2 comprises a processor 14 for processing input signals, such as microphone input signal(s). The processor 14 provides an electrical output signal based on the input signals to the processor 14.

The hearing device comprises a receiver 16 for converting the electrical output signal to an audio output signal.

The hearing device comprises a controller 12. The controller 12 is operatively connected to the first microphone 8 and to the processor 16. The controller 12 may be operatively connected to the second microphone 10. The controller 12 is configured to estimate the speech intelligibility indicator indicative of speech intelligibility based on one or more microphone input signals. The controller 12 comprises a speech intelligibility estimator 12a for estimating a speech intelligibility indicator indicative of speech intelligibility based on one or more microphone input signals. The controller 12 is configured to control the processor 14 based on the speech intelligibility indicator.

The speech intelligibility estimator 12a comprises a pitch estimator 12aa for estimating a pitch parameter of a first audio source. The speech intelligibility indicator is based on the pitch parameter and a direction of the first audio source. The speech intelligibility estimator 12a is configured to estimate the speech intelligibility indicator based on the pitch parameter and the direction of the first audio source

The processor 14 is configured to compensate for a hearing loss of a user and to provide an electrical output signal 15 based on input signals. The receiver 16 converts the electrical output signal 15 to an audio output signal to be directed towards an eardrum of the hearing device user.

The speech intelligibility estimator 12a may comprise a speech synthesizer 12ab for generating a reconstructed speech signal based on the pitch parameter. The speech intelligibility estimator 12a may be configured to estimate the speech intelligibility indicator based on the reconstructed speech signal provided by the speech synthesizer.

The speech intelligibility estimator 12a may comprise a short-time objective intelligibility (STOI) estimator 12ac. The short-time objective intelligibility estimator 12ac is configured to compare the reconstructed speech signal and a base speech signal based on one or more microphone input signals and to provide the speech intelligibility indicator based on the comparison. For example, the short-time objective intelligibility estimator 12ac compares the reconstructed speech signal (e.g. the reconstructed reference speech signal) and the base speech signal (e.g. the noisy speech signal) which is obtained based on the microphone input signals. In other words, the short-time objective intelligibility estimator 12ac assesses the correlation between the reconstructed speech signal and the base speech and uses the assessed correlation to provide a speech intelligibility indicator to the controller 12, or to the processor 14.

The speech intelligibility estimator 12a may comprise a harmonic model estimator 12ad operatively connected to the pitch estimator 12aa for provision of harmonic model parameters of the microphone input signals. The pitch estimator 12aa may be configured to derive the pitch parameter using the harmonic model parameters, and optionally a log-likelihood function.

In one or more exemplary hearing devices, the set of microphones 8, 10 comprises a second microphone 10 for provision of a second microphone input signal 11. The speech intelligibility estimator 12a may comprise a direction estimator 12ae for estimating the direction of the first audio source based on the first microphone input signal 9 and the second microphone input signal 11. The speech intelligibility estimator 12a may be configured to derive the speech intelligibility indicator based on the direction of the first audio source. For example, the pitch parameter and the direction of the first audio source (e.g. direction of arrival of the microphone input signal) are estimated jointly at the speech intelligibility estimator 12a by utilizing the spatio-temporal harmonic model for the desired microphone input signal received by one of the one or more microphones.

In one or more exemplary hearing devices, the hearing device 2 is configured to, if the speech intelligibility indicator meets a first criterion, select and apply a first processing scheme to the microphone input signals 9, 11. Otherwise, if the speech intelligibility indicator does not meet a first criterion, the hearing device 2 is configured to, continue applying to the microphone input signals the same processing scheme as previously applied. The first criterion may be based on a first intelligibility threshold. For example, the speech intelligibility indicator meets the first criterion when the speech intelligibility indicator is below the first intelligibility threshold. Alternatively, it may be envisaged that the speech intelligibility indicator meets the first criterion when the speech intelligibility indicator is equal or above the first intelligibility threshold.

In one or more exemplary hearing devices, the hearing device 2 may be configured to, if the speech intelligibility indicator meets a second criterion, select and apply a second processing scheme to the first microphone input signal. In one or more exemplary hearing devices, the first and/or second processing scheme comprises one or more of a beamforming scheme, a noise reduction scheme, a gain control scheme, and a compression scheme.

The hearing device 2 may be configured to select and apply the first and/or second processing scheme to the first microphone input signal 9 using the processor 14, and/or the controller 12.

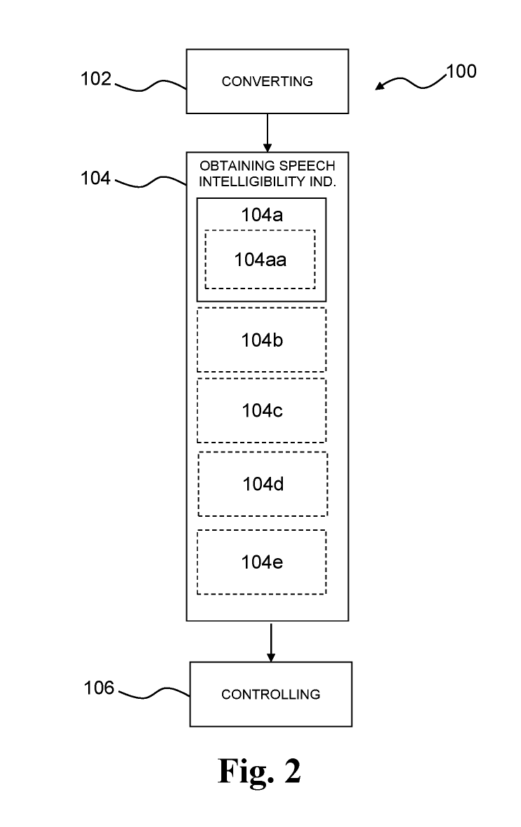

FIG. 2 is a flow diagram of an exemplary method of operating a hearing device according to the disclosure. The method 100 of operating a hearing device may be performed in a hearing device or in a hearing system according to this disclosure. The method 100 comprises converting 102 audio to one or more microphone input signals including a first microphone input signal. The method comprises obtaining 104 a speech intelligibility indicator indicative of speech intelligibility related to the first microphone input signal. Obtaining 104 the speech intelligibility indicator comprises obtaining 104a a pitch parameter of a first audio source and optionally a direction of the first audio source. The speech intelligibility indicator is based on the pitch parameter and a direction of the first audio source. The method comprises controlling 106 the hearing device based on the speech intelligibility indicator.

In one or more exemplary methods, obtaining 104a the pitch parameter of a first audio source comprises estimating 104aa the pitch parameter. Obtaining the speech intelligibility indicator 104 may comprise estimating 104b a speech intelligibility indicator based on the one or more microphone input signals, the pitch parameter and the direction of the first audio source.

In one or more exemplary methods, obtaining 104 the speech intelligibility indicator comprises generating 104c a reconstructed speech signal based on the pitch parameter, and determining 104d the speech intelligibility indicator based on the reconstructed speech signal. Obtaining 104 the speech intelligibility indicator may comprise comparing 104e the reconstructed speech signal and a base speech signal, e.g. using a short-time objective intelligibility estimator.

Obtaining 104 the speech intelligibility indicator may comprise obtaining harmonic model parameters of the microphone input signals and deriving the pitch parameter based on the harmonic model parameters. Obtaining 104 the speech intelligibility indicator may comprise estimating the direction of the first audio source based on the microphone input signals.

In one or more exemplary methods, controlling 106 the hearing device based on the speech intelligibility indicator comprises selecting and applying a first processing scheme to the microphone input signals if the intelligibility indicator meets a first criterion. The first criterion may be based on a first intelligibility threshold. The first processing scheme may comprise one or more of a beamforming scheme, a noise reduction scheme, a gain control scheme, and a compression scheme.

In one or more exemplary methods, obtaining 104a the pitch parameter of a first audio source may comprise receiving the pitch parameter from an external device, such as an accessory device. It may be envisaged that the estimation of the speech intelligibility indicator is performed at the external device, (e.g. online), wherein the hearing device is configured to provide the microphone input signals to an external device in order to obtain the speech intelligibility back.

It may be envisaged that the estimation of the speech intelligibility indicator and the processing of microphone input signals according to the speech intelligibility indicator is performed at the external device, (e.g. online), wherein the hearing device is configured to provide the microphone input signals to an external device in order to obtain the processed (e.g. noise reduced) microphone input signals or beamforming parameters.

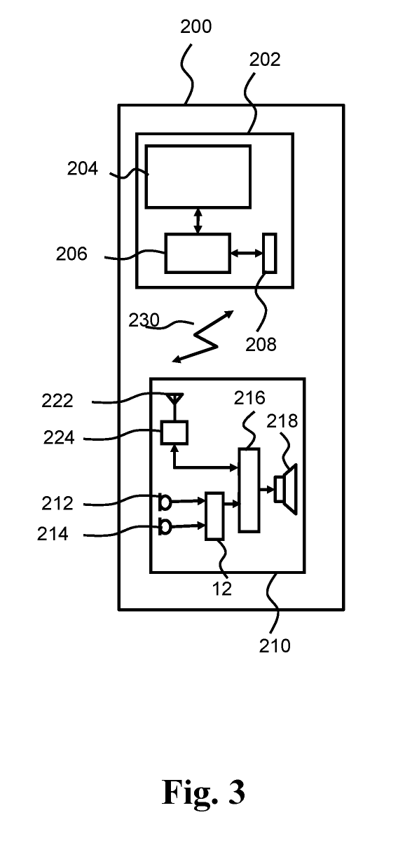

FIG. 3 is a block diagram of an exemplary hearing system 200 according to the disclosure. The hearing system 200 comprises an accessory device 202 comprising a processor 204, an interface 206 and a memory 208, and a hearing device 210.

The hearing system 200 comprises a set of microphones arranged in the hearing device, the set of microphones comprising a first microphone 212 for provision of a first microphone input signal (and optionally a second microphone 214), and a processor 216 for processing input signals and providing an electrical output signal based on input signals. The hearing system comprises a receiver 218 arranged in the hearing device for converting the electrical output signal to an audio output signal, and a controller 12 operatively connected to the set of microphones 212, 214. The controller 12 is configured to control the processor based on a speech intelligibility indicator as disclosed in relation to FIG. 1. The controller 12 in FIG. 3 is arranged in the hearing device 210. In one or more exemplary hearing systems, the controller 12 may be arranged in the accessory device 202.

The hearing system 200 is configured to estimate a speech intelligibility indicator indicative of speech intelligibility based on one or more microphone input signals. For example, the hearing device 210 may be configured to estimate a speech intelligibility indicator indicative of speech intelligibility based on one or more microphone input signals using the controller 12. In one or more exemplary hearing systems, the accessory device 202 may be configured to receive the microphone input signals transmitted by the hearing device 210 (e.g. via the antenna 222 and radio transceiver 224, and over the communication link 230) and to estimate the speech intelligibility indicator indicative of speech intelligibility based on one or more microphone input via the controller 12 arranged in the accessory device.

The hearing system 200 is configured to estimate a pitch parameter of a first audio source. The speech intelligibility indicator is based on the pitch parameter and a direction of the first audio source. For example, the hearing device 210 may be configured to estimate the pitch parameter of a first audio source using the controller 12 and derive the speech intelligibility based on the pitch parameter and the direction.

In one or more exemplary hearing systems, the accessory device 202 may be configured to receive the microphone input signals transmitted by the hearing device 210 (e.g. via the antenna 222 and radio transceiver 224, and over the communication link 230) and to estimate the pitch parameter of a first audio source using the controller 12 and to derive the speech intelligibility based on the pitch parameter and the direction.

The use of the terms “first”, “second”, “third” and “fourth”, etc. does not imply any particular order, but are included to identify individual elements. Moreover, the use of the terms first, second, etc. does not denote any order or importance, but rather the terms first, second, etc. are used to distinguish one element from another. Note that the words first and second are used here and elsewhere for labelling purposes only and are not intended to denote any specific spatial or temporal ordering. Furthermore, the labelling of a first element does not imply the presence of a second element and vice versa.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications and equivalents.

### LIST OF REFERENCES

2 hearing device

4 antenna

5 first wireless input signal

7 radio transceiver

8 first microphone

9 first microphone input signal

10 second microphone

11 second microphone input signal

12 controller

12a speech intelligibility estimator

12aa pitch estimator

12ab speech synthesizer

12ac short-time objective intelligibility (STOI) estimator

12ad harmonic model estimator

12ae direction estimator

14 processor

16 receiver

100 method of operating a hearing device

102 converting audio to one or more microphone input signals

104 obtaining a speech intelligibility indicator

104a obtaining a pitch parameter of a first audio source

104aa estimating the pitch parameter

104b estimating a speech intelligibility indicator based on the one or more microphone input signals

104c generating a reconstructed speech signal based on the pitch parameter

104d determining the speech intelligibility indicator based on the reconstructed speech signal

104e comparing the reconstructed speech signal and a base speech signal

106 controlling the hearing device based on the speech intelligibility indicator

200 hearing system

202a ccessory device

204 processor

206 interface

208 memory

210 hearing device

212 first microphone

214 second microphone

216 processor

218 receiver

222 antenna

224 radio transceiver

230 communication link

1. A hearing device comprising:
a set of microphones comprising a first microphone for provision of a first microphone input signal;
a processor configured to provide an electrical output signal based on the first microphone input signal;
a receiver configured to provide an audio output signal based on the electrical output signal; and
a controller operatively connected to the set of microphones, the controller comprising a speech intelligibility estimator for estimating a speech intelligibility indicator indicative of speech intelligibility based on one or more microphone input signals that include the first microphone input signal, wherein the controller is configured to control the processor based on the speech intelligibility indicator;
wherein the speech intelligibility estimator comprises a pitch estimator for estimating a pitch parameter of a first audio source, and wherein the speech intelligibility indicator is based on the pitch parameter and a direction of the first audio source.

2. The hearing device according to claim 1, wherein the speech intelligibility estimator comprises a speech synthesizer configured to generate a reconstructed speech signal based on the pitch parameter, and wherein the speech intelligibility indicator is based on the reconstructed speech signal.

3. The hearing device according to claim 2, wherein the speech intelligibility estimator comprises a short-time objective intelligibility estimator, wherein the short-time objective intelligibility estimator is configured to compare the reconstructed speech signal and a base speech signal.

4. The hearing device according to claim 1, wherein the speech intelligibility estimator comprises a harmonic model estimator operatively connected to the pitch estimator for provision of a harmonic model parameter, and wherein the pitch parameter is based on the harmonic model parameter.

5. The hearing device according to claim 1, wherein the set of microphones comprises a second microphone for provision of a second microphone input signal; and
wherein the speech intelligibility estimator comprises a direction estimator for estimating the direction of the first audio source based on the first microphone input signal and the second microphone input signal.

6. The hearing device according to claim 1, wherein the hearing device is configured to, if the speech intelligibility indicator meets a first criterion, apply a first processing scheme.

7. The hearing device according to claim 1, wherein the hearing device is configured to, if the speech intelligibility indicator does not meet a first criterion, continue applying a same processing scheme as previously applied.

8. The hearing device according to claim 6, wherein the first criterion is based on a first intelligibility threshold.

9. The hearing device according to claim 8, wherein the speech intelligibility indicator meets the first criterion when the speech intelligibility indicator is below the first intelligibility threshold.

10. The hearing device according to claim 6, wherein the hearing device is configured to, if the speech intelligibility indicator meets a second criterion, apply a second processing scheme that is different from the first processing scheme.

11. The hearing device according to claim 10, wherein the first processing scheme, the second processing scheme, or each of the first and second processing schemes, comprises a beamforming scheme, a noise reduction scheme, a gain control scheme, a compression scheme, or a combination of the foregoing.

12. A method of operating a hearing device, comprising:
providing one or more microphone input signals including a first microphone input signal;
obtaining a speech intelligibility indicator indicative of speech intelligibility related to the first microphone input signal, wherein the act of obtaining the speech intelligibility indicator comprises obtaining a pitch parameter of a first audio source, and wherein the speech intelligibility indicator is based on the pitch parameter and a direction of the first audio source; and
controlling the hearing device based on the speech intelligibility indicator.

13. The method according to claim 12, wherein the act of obtaining the pitch parameter of the first audio source comprises estimating the pitch parameter, and wherein the act of obtaining the speech intelligibility indicator comprises estimating a speech intelligibility indicator based on the one or more microphone input signals.

14. The method according to claim 12, wherein the act of obtaining the speech intelligibility indicator comprises generating a reconstructed speech signal based on the pitch parameter, and wherein the speech intelligibility indicator is based on the reconstructed speech signal.

15. A hearing system comprising an accessory device and a hearing device, wherein the hearing system comprises:
a set of microphones arranged in the hearing device, the set of microphones comprising a first microphone for provision of a first microphone input signal;
a processor configured to provide an electrical output signal based on the first microphone input signal;
a receiver arranged in the hearing device for providing an audio output signal based on the electrical output signal; and
a controller operatively connected to the set of microphones, wherein the controller is configured to control the processor based on a speech intelligibility indicator;
wherein the hearing system is configured to estimate a speech intelligibility indicator indicative of speech intelligibility based on one or more microphone input signals that include the first microphone input signal; and
wherein the hearing system is configured to estimate a pitch parameter of a first audio source, and wherein the speech intelligibility indicator is based on the pitch parameter and a direction of the first audio source.
